(19) United States
(12) Patent Application Publication
(10) Pub. No.: US 2023/0294585 A1
(43) Pub. Date: Sep. 21, 2023

(54) CAR SEAT ASSEMBLIES INCLUDING INTERCHANGEABLE ACCESSORIES

(71) Applicant: Graco Children's Products, Inc., Atlanta, GA (US)

(72) Inventors: Adam McKenzie, Atlanta, GA (US); Douglas Kim, Atlanta, GA (US); Thomas Jake Mitchell, Atlanta, GA (US); Rachael Knapp, Atlanta, GA (US)

(21) Appl. No.: 18/117,690

(22) Filed: Mar. 6, 2023

Related U.S. Application Data
(60) Provisional application No. 63/269,376, filed on Mar. 15, 2022.

(51) Int. Cl. B60N 3/10; B60N 3/00

(52) U.S. Cl. CPC B60N 3/103; B60N 3/002; B60N 2/28

(57) ABSTRACT

A car seat assembly includes a car seat and an accessory. The car seat includes a base defining a right receiver port and a left receiver port. The accessory includes a right clip and a left clip removably securable within the respective right and left receiver ports to removably secure the accessory to the car seat. A method for securing the accessory to the car seat includes aligning the right and left clips with the respective right and left receiver ports. The method further includes introducing the right and left clips into the respective right and left receiver ports. The method further includes pushing the accessory toward the car seat until the right and left clips are secured within the respective right and left receiver ports.

### CROSS-REFERENCE TO RELATED APPLICATION

This application claims the benefit of U.S. Application No. 63/269,376, filed Mar. 15, 2022, the entirety of which is hereby incorporated by reference.

### TECHNICAL FIELD

The present disclosure relates generally to car seats, and in particular, to systems for attaching car seat accessories.

### BACKGROUND

Accessories may be attached to car seats. A need remains for systems to removably secure one or more accessories to car seats.

### SUMMARY

The present disclosure describes car seat assemblies for interchangeably securing accessories to car seats.

In aspects, the present disclosure describes a car seat assembly including a car seat and an accessory. The car seat includes a base defining a right receiver port and a left receiver port. The accessory includes a right clip and a left clip removably securable within the respective right and left receiver ports to removably secure the accessory to the car seat.

In aspects, the present disclosure describes a method for securing the accessory to the car seat. The method includes aligning the right and left clips with the respective right and left receiver ports. The method further includes introducing the right and left clips into the respective right and left receiver ports. The method further includes pushing the accessory toward the car seat until the right and left clips are secured within the respective right and left receiver ports.

### BRIEF DESCRIPTION OF THE DRAWINGS

FIG. 1A is a perspective view of a car seat assembly including a car seat and an accessory secured to the car seat.

FIG. 1B is a partial rear perspective view of the car seat assembly of FIG. 1A showing a button assembly for releasing the accessory.

FIG. 2A is a partial front view of the car seat assembly of FIG. 1A showing an interior of a receiver port.

FIG. 2B is a partial view of the car seat assembly of FIG. 2A showing the receiver port and a button tab.

FIG. 3A is a partial cross-sectional view of the car seat assembly of FIG. 1A showing the button assembly including the button and the button tab.

FIG. 3B is an interior view of the car seat assembly of FIG. 3A showing a rear view of the button assembly.

FIG. 4A is a perspective view of a clip including a rigid plate.

FIG. 4B is a perspective view of the clip of FIG. 4A with the rigid plate removed.

FIG. 4C is a perspective view of the rigid plate.

FIG. 5A is a perspective view of an anti-rebound bar assembly.

FIG. 5B is an exploded view of the anti-rebound bar assembly of FIG. 5A.

FIG. 6 is a partial perspective view of a car seat assembly including a device holder secured within a receiver port.

FIG. 7 is a partial perspective view of a car seat assembly including a snack tray secured within a receiver port.

FIG. 8 is a partial perspective view of a car seat assembly including a cup holder secured within a receiver port.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The present disclosure describes car seat assemblies for interchangeably securing accessories to car seats. An attachment system that can be applied to a number of accessories allowing them all to be interchanged using the same receiver on the car seat.

Car seats may be provided with accessories, such as removable cup holders. These can be installed or removed when needed. The same attachment may be used to secure other accessories, for example, a removable anti-rebound bar (ARB). This may allow a user to install the ARB in a rear facing mode of the car seat, and replace it with other accessories, for example, cup holders, in a forward facing mode. Thus, cup holders may be interchanged with other accessories such as a snack tray or a device holder. Additionally, electrical contact points, which may be coupled to a power source, may be added that allow for powered accessories such as a fan, music device, charger, or other electronic entertainment. Thus, car seat assemblies according to the present disclosure allow a customer to choose the accessory that suits their real time needs without having additional unique attachment points on the car seat. Such an interchangeable interface could be applied in any suitable child restraint system, including all in ones, infant car sears, convertibles, and boosters.

In aspects, the car seat has a receiver port on a front portion of the arm rest. The port may be tapered, reducing in size toward the seat back. For example, a cross-sectional area of the port may decrease between a front end adjacent to a front of the seat and a rear end adjacent to a rear of the seat. Inside the port is a button tab that actuates orthogonally to the center plane of the port. The user can actuate the button tab by depressing a button below the port. The accessory may have a clip with a similar, same, or conforming taper as the port so that it can be inserted and has reducing clearance the further it is pushed in. A recess may be provided in the side of the clip that aligns with the button tab on the side of the port. The recess may be sufficiently larger than the button tab so that the button tab fits inside the recess. The tip of the clip may be tapered or rounded to depress the button upon insertion. When the clip is inserted into the port, the button tab may be pushed out of the way. The recess then passes in front of the button tab. A spring feature on the button may allow it to fall into the recess, locking the two parts together. If the user depresses the button again, the accessory can be removed and another accessory with the same clip may replace it. The clip can be symmetric or it can have a left hand and right hand version. The left port can be configured as a mirror of the right port, or may have the same configuration as the right port.

In aspects, the present disclosure describes a car seat assembly including a car seat and an accessory. The car seat includes a base defining a right receiver port and a left receiver port. The accessory includes a right clip and a left clip removably securable within the respective right and left receiver ports to removably secure the accessory to the car seat.

In aspects, the present disclosure describes a method for securing the accessory to the car seat. The method includes aligning the right and left clips with the respective right and left receiver ports. The method further includes introducing the right and left clips into the respective right and left receiver ports. The method further includes pushing the accessory toward the car seat until the right and left clips are secured within the respective right and left receiver ports.

Using assemblies and methods according to the present disclosure, a user may be able to install interchangeable accessories, for example, an ARB when the seat is in rear facing mode to meet safety requirements. The ARB is able to be shipped separate from the child restraint system, making a smaller package profile. The installation does not require tools. When the seat is in forward facing mode and the ARB is removed, other accessories such as cup holders, snack trays, or device holders, can be installed. Additional accessories can be added on at a later time to meet additional user.

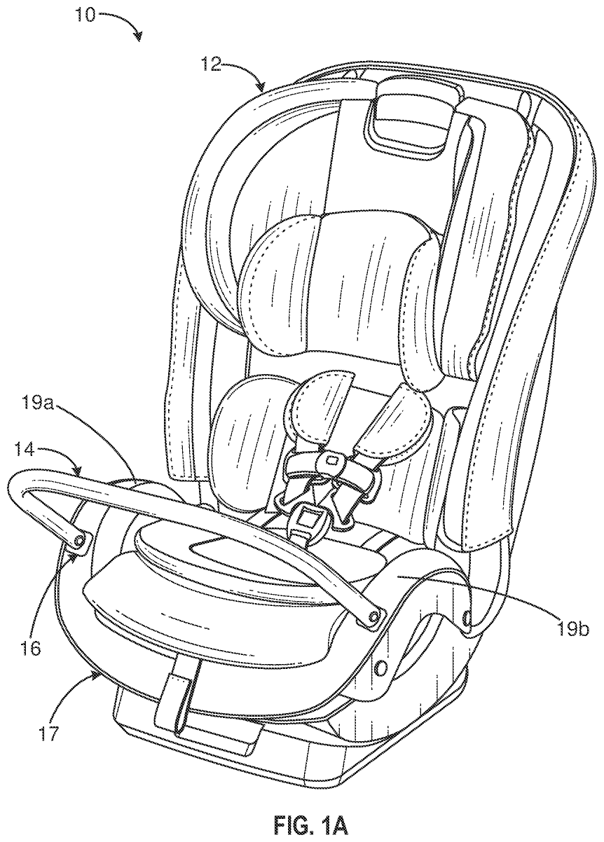

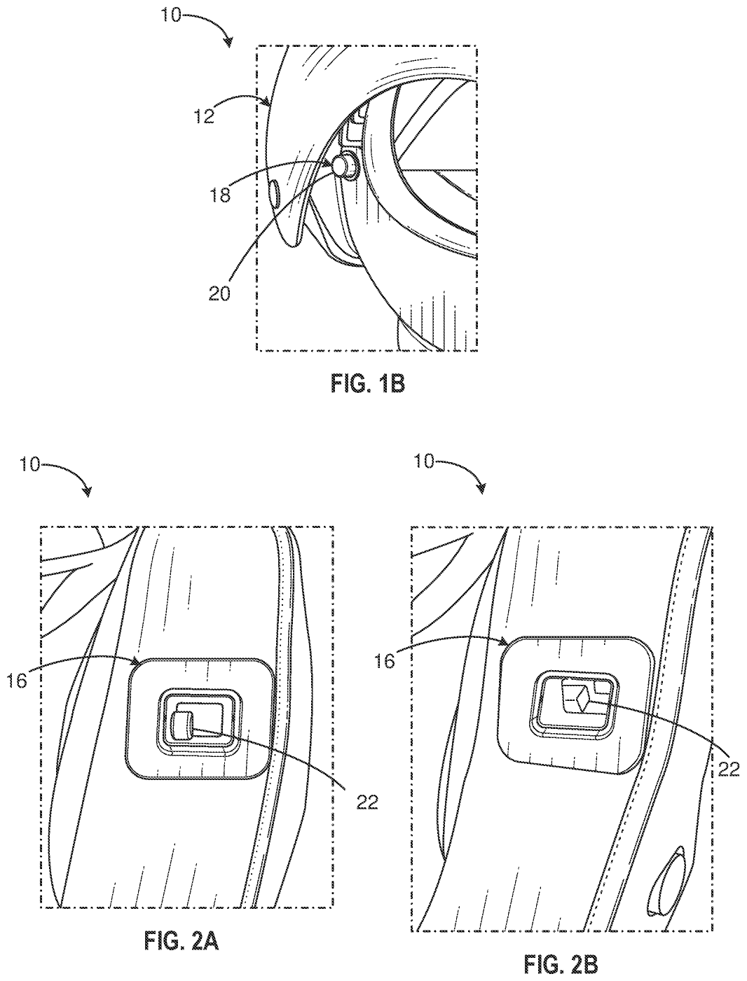

FIG. 1A is a perspective view of a car seat assembly 10 including a car seat 12 and an accessory 14 secured to the car seat 12 within a receiving port 16.

The car seat 12 may include a base 17, the base 17 defining a right receiver port and a left receiver port (for example, right and left ports 16). In aspects, the base 17 defines right and left panels 19a and 19b. The right and left receiver ports 16 may be located on the respective right and left panels 19a and 19b. In some aspects, the right and left receiver ports 16 are located on respective inclined surfaces of the respective right and left panels 19a and 19b.

FIG. 1B is a partial rear perspective view of the car seat assembly of FIG. 1A showing a button assembly 18 for releasing the accessory 14 from the receiving port. In aspects, the button assembly 18 is placed below a respective receiver port 16. The right and left ports 16 may be associated with respective button assemblies 18. The button assembly may include a button 20 and a button tab (not shown in FIG. 1B).

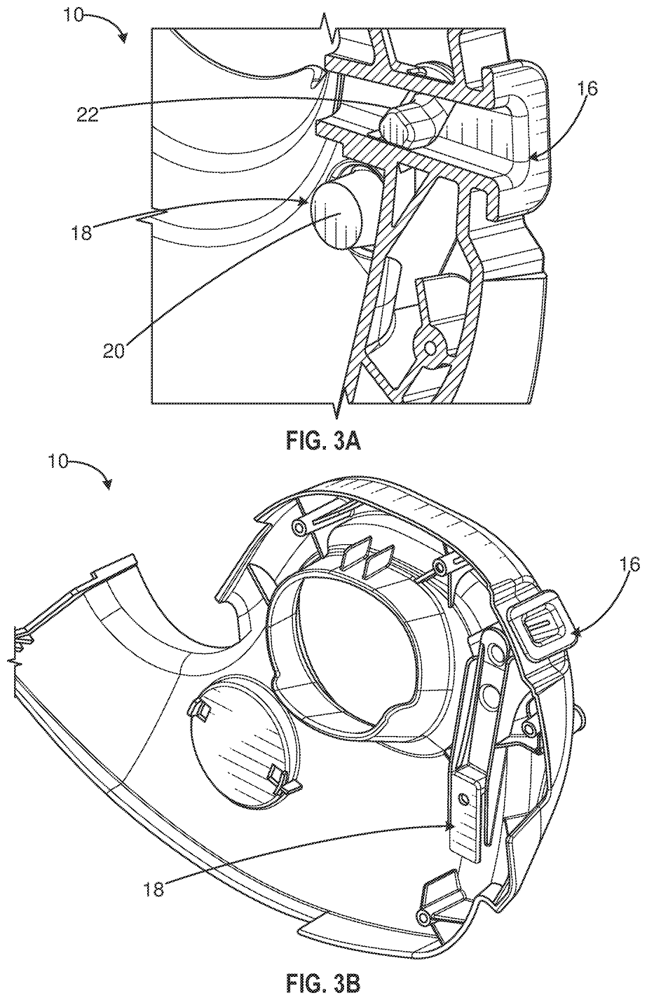

FIG. 2A is a partial front view of the car seat assembly 10 of FIG. 1A showing an interior of the receiver port 16. FIG. 2B is a partial view of the car seat assembly of FIG. 3A showing the receiver port 16 and a button tab 22 of the button assembly. In aspects, each respective port defines a longitudinally tapering interior. In aspects, each respective port defines a substantially symmetric interior contour. In other aspects, each respective port defines a substantially asymmetric interior contour.

FIG. 3A is a partial cross-sectional view of the car seat assembly 10 of FIG. 1A showing the button assembly 18 including the button 20 and the button tab 22. FIG. 3B is an interior view of the car seat assembly 10 of FIG. 3A showing a rear view of the button assembly 18. The button assembly 18 includes the button 20 coupled to the button tab 22. The button tab 22 may be biased to at least partially protrude into an interior of a respective port of the right receiver port and the left receiver port 16. The button tab 22 may engage a respective clip received in the respective port 16 to lock the respective clip in the respective port. For example, the accessory 14 may have one or two clips received in one or both of the ports 16 to secure the accessory 14 to the car seat 12.

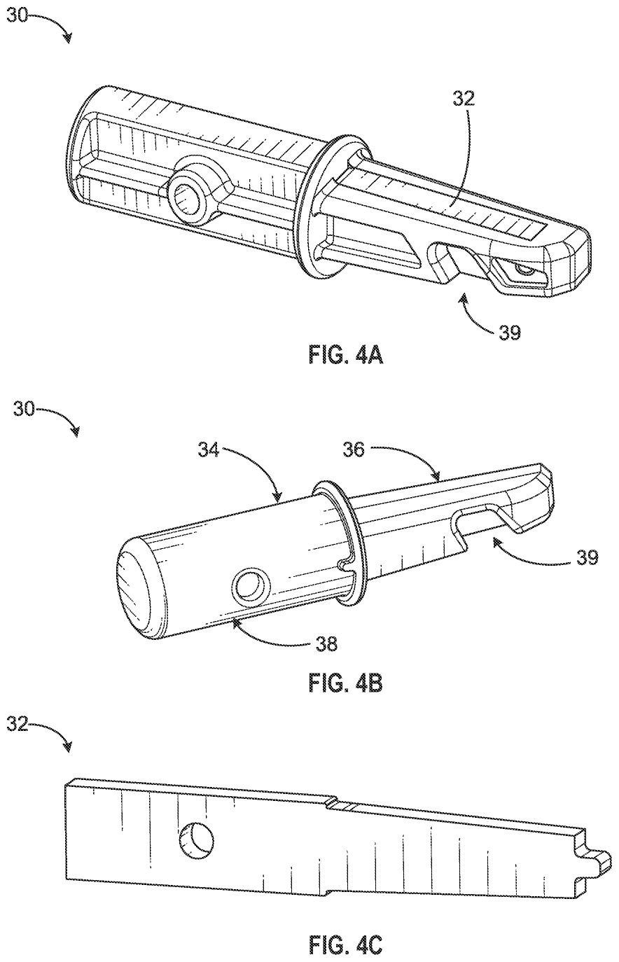

FIG. 4A is a perspective view of a clip 30 including a rigid plate 32. FIG. 4B is a perspective view of the clip 30 of FIG. 4A with the rigid plate removed. FIG. 4C is a perspective view of the rigid plate 32. The clip 30 includes a clip body 34. The clip body 34 may be made of a plastic, a metal, an alloy, or any suitable rigid material.

In aspects, the clip 30 defines a clip portion 36 that substantially conforms to the respective port interior. In aspects, the clip 30 includes a cylindrical portion 38 adjacent the clip portion 36. The cylindrical portion 36 may be secured to the accessory 14. The clip 30 body may be integrally formed, for example, with the clip portion 36 and the cylindrical portion 38 being unitary.

The rigid plate 32 may provide the clip 30 with adequate retaining force against the button assembly 18. While the clip 30 is shown with rigid plate 32, in other aspects, the rigid plate may not be present, and a portion of the clip 30 may function similarly as the rigid plate. In aspects, the rigid plate includes a metal or an alloy. For example, the rigid plate may be formed of a steel.

In aspects, the clip 30 defines a tip portion (which may be a part of the clip portion 36 or the clip portion 36 itself) configured to laterally push the button tab 22, and a clip recess 39 configured to receive the button tab.

Turning back to FIGS. 3A and 3B, the button 20 is configured to disengage the button tab 22 from the clip 30 in response to a force applied to the button 20, to allow the clip 30 to be released from the respective port 16. In aspects, the button assembly 18 may further include a spring configured to bias the tab 22 to at least partially protrude into the interior of the respective port 16.

The accessory 14 may include a right clip and a left clip, for example, substantially similar to clips 30 or mirror image thereof. The left and right clips may be removably securable within the respective right and left receiver ports 16 to removably secure the accessory 14 to the car seat 12.

In aspects, the accessory 14 is an anti-rebound bar extending across the car seat 12.

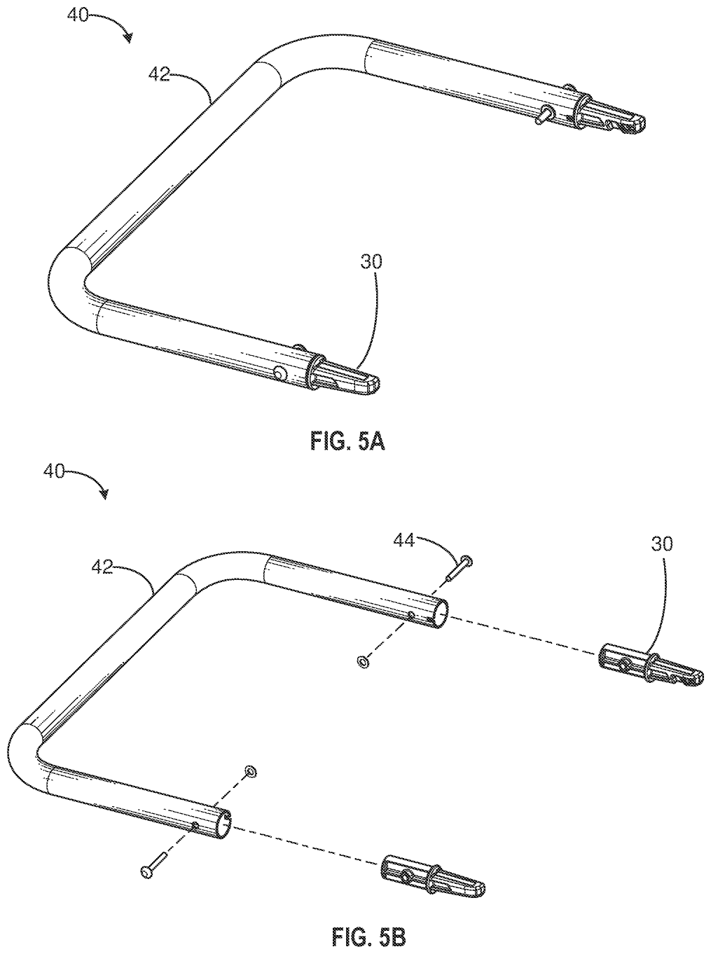

FIG. 5A is a perspective view of an anti-rebound bar assembly 40. FIG. 5B is an exploded view of the anti-rebound bar assembly 40 of FIG. 5A. The anti-rebound bar assembly 40 includes a bar 42 and the ends of which clips 30 are secured, for example, by a fastener 44. The fastener 44 may include a screw and a nut, or a clip, or any other suitable fastener. In aspects, the clips 30 may be adhesively secured to the bar 42. The bar 42 may be made of a rigid plastic, a metal, or an alloy, or combinations thereof

The anti-rebound bar assembly 40 may be secured as accessory 14 to the car seat. In aspects, the accessory 14 is a first accessory, and a second accessory is securable within one of the right and left receiver ports 16. For example, the anti-rebound bar assembly 40 may be removed from the car seat 12, and another accessory secured to the car seat 12.

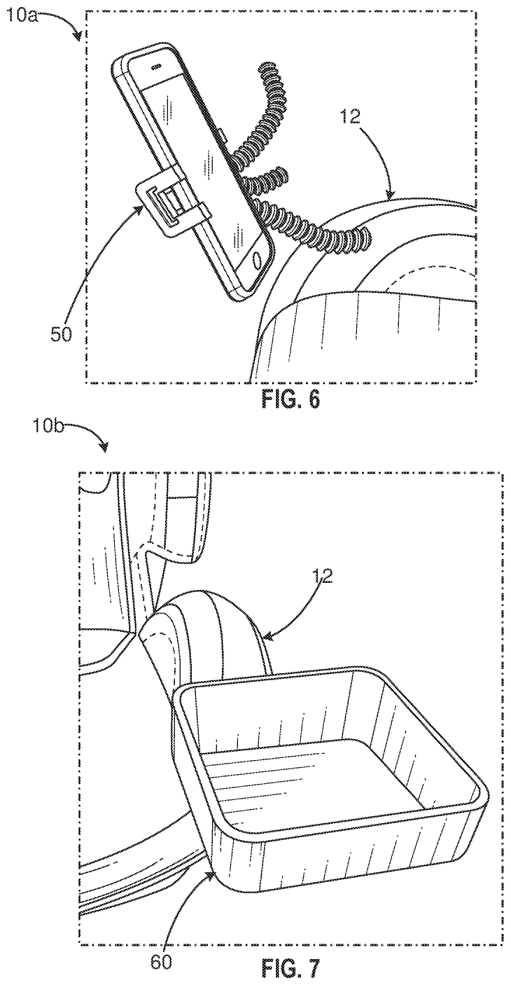

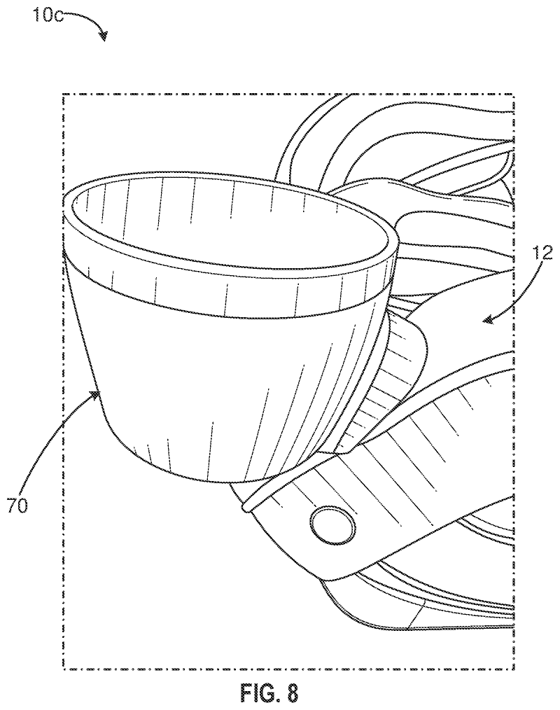

FIG. 6 is a partial perspective view of a car seat assembly 10a including a device holder 50 secured within a receiver port 16. FIG. 7 is a partial perspective view of a car seat assembly 10b including a snack tray 60 secured within a receiver port. FIG. 8 is a partial perspective view of a car seat assembly 10c including a cup holder 70 secured within a receiver port.

Thus, different accessories may be interchangeably and removably secured to the car seat 12. Thus, the present disclosure provides car seat assemblies with easily interchangeable accessories.

The present disclosure provides methods of securing accessories to car seats. While aspects of methods are described with reference to car seat assembly 10, the methods described may be used to operate any car seat assembly according to the present disclosure.

In aspects, a method for securing the accessory 14 to the car seat 12 of the car seat assembly 10 includes aligning the right and left clips 30 of the accessory 14 with the respective right and left receiver ports 16 of the car seat 12. The method further includes introducing the right and left clips 30 into the respective right and left receiver ports 16. The method further includes pushing the accessory 14 toward the car seat 12 until the right and left clips 30 are secured within the respective right and left receiver ports 16.

In aspects, the method further includes allowing the respective button tabs 22 of a right button assembly and a left button assembly 18 to be biased into the respective right and left clip recesses 39 to lock the right and left clips 30 respectively into the right and left receiver port 16. In aspects, the method further includes pushing respective buttons 20 of the right and left button assemblies 18 to respectively release the right and left clips 30 from the right and left receiver ports 16 to release the accessory 14 from the car seat 12.

In aspects, an accessory may only include a single clip 30, and methods may be practiced to secure or remove the accessory by attaching or releasing the single clip 30.

In aspects, the accessory 14 is a first accessory, and the method may further include securing a second accessory to one of the right or left receiver ports 16.

Embodiments may include a method for securing an accessory to a car seat of the car seat assembly. The method may include aligning the right and left clips of the accessory with the respective right and left receiver ports of the car seat, introducing the right and left clips into the respective right and left receiver ports, and pushing the accessory toward the car seat until the right and left clips are secured within the respective right and left receiver ports. The accessory may be a first accessory, further comprising securing a second accessory to one of the right receiver port or the left receiver port.

Some methods may include allowing the respective button tabs of a right button assembly and a left button assembly to be biased into the respective right clip recess and the left clip recess to lock the right clip and the left clip respectively into the right receiver port and the left receiver port.

Some methods may include pushing respective buttons of the right button assembly and the left button assembly to respectively release the right clip and the left clip from the right receiver port and the left receiver port to release the accessory from the car seat.

While certain aspects have been described, further variations are within the scope of the present disclosure. For example, the clip 30 could be on the car seat 12 and the receiver port could 16 be on the accessory 14. The button assembly 18 could have any number of alternative designs, which may not require a spring. For example, the button assembly 18 may include a pin, rotating parts, a push-push feature, a T-slot alternate geometry, or snaps that interface with a feature on a mating part.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A car seat assembly comprising:
a car seat comprising a base, the base defining a right receiver port and a left receiver port; and
an accessory comprising a right clip and a left clip, wherein the left and right clips are removably securable within the respective right and left receiver ports to removably secure the accessory to the car seat.

2. The car seat assembly of claim 1, wherein the accessory is an anti-rebound bar extending across the car seat.

3. The car seat assembly of claim 1, further comprising a button assembly, wherein the button assembly comprises a button coupled to a button tab, wherein the button tab is biased to at least partially protrude into an interior of a respective port of the right receiver port and the left receiver port.

4. The car seat assembly of claim 3, wherein the button tab engages a respective clip received in the respective port to lock the respective clip in the respective port.

5. The car seat assembly of claim 4, wherein the respective clip defines a tip portion configured to laterally push the button tab and a clip recess configured to receive the button tab.

6. The car seat assembly of claim 3, wherein the button is configured to disengage the button tab from the clip in response to a force applied to the button to allow the respective clip to be released from the respective port.

7. The car seat assembly of claim 3, wherein the button assembly further comprises a spring configured to bias the tab to at least partially protrude into the interior of the respective port.

8. The car seat assembly of claim 1, wherein the button is placed below the respective receiver port.

9. The car seat assembly of claim 1, wherein the base defines right and left panels, and wherein the right and left receiver ports are located on the respective right and left panels.

10. The car seat assembly of claim 9, wherein the right and left receiver ports are located on respective inclined surfaces of the respective right and left panels.

11. The cart seat assembly of claim 1, wherein each respective port defines a longitudinally tapering interior.

12. The car seat assembly of claim 1, wherein each respective port defines a substantially symmetric interior contour.

13. The car seat assembly of claim 1, wherein each respective port defines a substantially asymmetric interior contour.

14. The car seat assembly of claim 1, wherein each respective clip defines a clip portion that substantially conforms to the respective port interior.

15. The car seat assembly of claim 14, wherein each respective clip comprises a cylindrical portion adjacent the clip portion, wherein the cylindrical portion is secured to the accessory.

16. The car seat assembly of claim 1, wherein the clip comprises a rigid plate.

17. The car seat assembly of claim 16, wherein the rigid plate comprises a metal or an alloy.

18. The car seat assembly of claim 1, wherein the accessory is a first accessory, and wherein a second accessory is securable within one of the right and left receiver ports.

19. The car seat assembly of claim 18, wherein the second accessory comprises a device holder, a snack tray, or a cup holder.

20. A car seat assembly comprising:
a car seat comprising a base, the base defining a right receiver port and a left receiver port;
an accessory comprising a right clip and a left clip, wherein the left and right clips are removably securable within the respective right and left receiver ports to removably secure the accessory to the car seat, wherein the accessory is an anti-rebound bar extending across the car seat; and
a button assembly, wherein the button assembly comprises a button coupled to a button tab, wherein the button tab is biased to at least partially protrude into an interior of a respective port of the right receiver port and the left receiver port;
wherein the button tab engages a respective clip received in the respective port to lock the respective clip in the respective port, and wherein the respective clip defines a tip portion configured to laterally push the button tab and a clip recess configured to receive the button tab.
